(19) United States
(12) Patent Application Publication
(10) Pub. No.: US 2024/0113430 A1
(43) Pub. Date: Apr. 4, 2024

(54) ANTENNA SYSTEM FOR MOBILE ELECTRONIC DEVICES

(71) Applicant: Meta Platforms Technologies, LLC, Menlo Park, CA (US)

(72) Inventors: Zhong Ji, San Jose, CA (US); Yonghua Wei, San Diego, CA (US); Md Rashidul Islam, Fremont, CA (US); Huan Liao, San Jose, CA (US); Geng Ye, Union City, CA (US); Bruno Cendon Martin, Palo Alto, CA (US)

(21) Appl. No.: 18/053,292

(22) Filed: Nov. 7, 2022

Related U.S. Application Data
(60) Provisional application No. 63/378,322, filed on Oct. 4, 2022.

(51) Int. Cl. H01Q 5/328; H01Q 1/52; H01Q 9/04; H01Q 21/28

(52) U.S. Cl. CPC H01Q 5/328; H01Q 1/526; H01Q 9/045; H01Q 21/28

(57) ABSTRACT

The disclosed system may include a conductive enclosure, a first printed circuit board (PCB) that includes multiple antenna feeds, and a second PCB that includes a grounding layer and one or more sensors. A first antenna feed may be electrically connected to the conductive enclosure, and a second antenna feed may be electrically connected to the grounding layer of the second PCB. As such, the grounding layer of the second PCB may act as a radiating element for a second antenna. Various other mobile electronic devices, apparatuses, and methods of manufacturing are also disclosed.

### CROSS REFERENCE TO RELATED APPLICATION

This application claims priority to U.S. Provisional Application No. 63/378,322, filed Oct. 4, 2022, the disclosure of which is incorporated, in its entirety, by this reference.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIG. 1A is a plan view of an example wristband system, according to at least one embodiment of the present disclosure.

FIG. 1B is a side view of the example wristband system of FIG. 1A, according to at least one embodiment of the present disclosure.

FIG. 2A is a perspective view of an example wristband system, according to at least one embodiment of the present disclosure.

FIG. 2B is a side view of another example wristband system, according to at least one embodiment of the present disclosure.

FIG. 2C is a perspective view of another example wristband system, according to at least one embodiment of the present disclosure.

FIG. 3 illustrates a side, cross-sectional view of an antenna architecture that may be implemented in a mobile electronic device.

FIG. 4 illustrates a side, cross-sectional view of an alternative antenna architecture that may be implemented in a mobile electronic device.

FIG. 5A illustrates a top view of an embodiment in which an antenna feed is electrically connected to a printed circuit board (PCB) through a conductive substrate.

FIG. 5B illustrates a top view of an alternative embodiment in which an antenna feed is electrically connected directly to a grounding layer of a PCB.

FIG. 6A illustrates a top view of an embodiment in which a PCB is grounded at multiple locations to a conductive enclosure.

FIG. 6B illustrates a top view of an alternative embodiment in which a PCB is grounded at multiple different locations to the conductive enclosure.

FIG. 7A illustrates a top view of an embodiment in which a display shield is grounded to a PCB

FIG. 7B illustrates a top view of an alternative embodiment in which a display shield is grounded at different locations to the PCB.

FIG. 8 illustrates an embodiment of a chart showing comparison simulation data of different antenna architectures.

FIG. 9 is a flow diagram of an exemplary method for manufacturing a mobile electronic device that includes one or more of the antenna architectures described herein.

FIG. 10 is an illustration of exemplary augmented-reality glasses that may be used in connection with embodiments of this disclosure.

FIG. 11 is an illustration of an exemplary virtual-reality headset that may be used in connection with embodiments of this disclosure.

Throughout the drawings, identical reference characters and descriptions indicate similar, but not necessarily identical, elements. While the exemplary embodiments described herein are susceptible to various modifications and alternative forms, specific embodiments have been shown byway of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION OF EXEMPLARY EMBODIMENTS

The present disclosure is generally directed to an improved antenna design that strategically places different types of antennas at locations that are designed to optimize each antenna's operating properties. For smartwatches or other mobile devices with full metal enclosures (or other types of conductive enclosures), antennas including long-term evolution (LTE), global positioning system (GPS), Wifi, ultrawideband (UWB), or other types of antennas are often placed near the back cover of the smartwatch (e.g., the portion that rests on a user's wrist). This area, which may include heart rate or other sensors, may have limited space and, because of its proximity to a user's wrist, antennas that operate above 1 GHz (e.g., GPS, WiFi, UWB, etc.) may experience significant drops in performance due to signal absorption by the user's arm.

The embodiments described herein may physically separate antennas that operate at different frequencies and may strategically place those antennas within a customized antenna architecture. For example, in at least some embodiments, LTE low band and LTE mid-high band may be separated into two different antennas. In some cases, the LTE low band antenna may use a grounding layer on a printed circuit board (PCB) as a radiating element for the antenna. This PCB may be near the back cover of the mobile device, near the user's wrist when worn by a user. The PCB may include various sensors including heart rate, pulse oximetry, and other sensors. Because the LTE low band antenna operates below 1 GHz, the LTE low band antenna may experience less signal absorption by the user's wrist.

In some cases, the antenna feed for the LTE low band antenna may flow through a conductive element on the inner surface of the smartwatch's back cover. This conductive element or conductive portion may be formed, for example, using laser direct structuring (LDS)) on the back cover. As such, the LTE low band antenna may use a PCB that is structurally lower and closer to the user's wrist. In this position, the LTE low band antenna may use that PCB's grounding layer and/or the PCB's conductive traces as radiating elements. This LTE low band antenna may also avoid any electrical connection to the device's conductive (e.g., metal) enclosure.

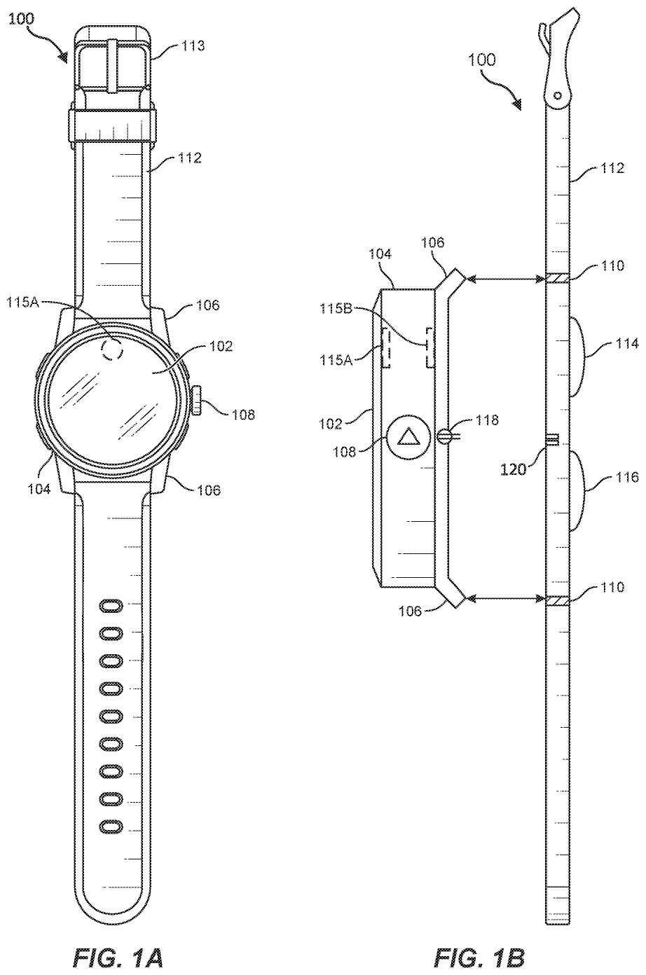

This, in turn, may allow the LTE mid-high band, GPS, and potentially other antennas to be connected to and use the mobile device's metal enclosure as a radiating element. Accordingly, the LTE mid-high band antenna may be moved structurally higher and further away from the user's wrist. This may reduce signal absorption and may provide improved antenna efficiency. Still further, a conductive display shield that provides a barrier between the mobile device's internal components and the touchscreen display may itself be used as a radiating element for Wifi, UWB, or other high-frequency antennas. By moving these higher-frequency antennas structurally further from the user's wrist, each antenna's performance may be improved. Moreover, using existing components within the mobile device as radiating elements may allow other radiating elements to be removed and, as such, may free up space in the mobile device for other electronic or mechanical components. These embodiments will be described further below with regard to FIGS. 1A-11.

Features from any of the embodiments described herein may be used in combination with one another in accordance with the general principles described herein. These and other embodiments, features, and advantages will be more fully understood upon reading the following detailed description in conjunction with the accompanying drawings and claims.

Mobile electronic devices often use many different types of antennas for communication on different frequency bands. For instance, current smartwatches may implement wide- and multi-band long-term evolution (LTE), global positioning system (GPS), wireless fidelity (WiFi), Bluetooth™, near field communication (NFC), or other types of antennas. These different types of antennas may provide long- and short-range communications with other electronic devices and with networks such as cellular networks or the internet.

However, as mobile devices become ever smaller, the amount of space available for these different types of antennas may be limited. Moreover, because of the small size, the amount of bandwidth achievable on any given antenna may be limited. Still further, because mobile devices such as smartwatches are often designed with metal enclosures, placing multiple different types of antennas in different locations where they can receive sufficient operational signal strength may be complicated. In some instances, the size of the mobile device may be increased to accommodate larger antennas. This increased size may, at least in some cases, improve antenna bandwidth and efficiency. However, larger sizes for smartwatches and other mobile devices may be less desirable, as additional weight and bulk in a mobile (especially wearable) device are typically unwanted. Still further, having a metal enclosure may limit how and where different types of antennas may be placed and operated within a mobile device.

As noted above, wearable devices may be configured to be worn on a user's body, such as on a user's wrist or arm. Such wearable devices may be configured to perform a variety of functions. A wristband system, for example, may be an electronic device worn on a user's wrist that performs functions such as delivering content to the user, executing social media applications, executing artificial-reality applications, messaging, web browsing, sensing ambient conditions, interfacing with head-mounted displays, monitoring the health status associated with the user, etc. In some examples, a wristband system may include a watch band that detachably couples to a watch body. The watch body may include a coupling mechanism for electrically and mechanically coupling the watch body (e.g., the enclosure or capsule) to the watch band (e.g., the cradle). At least in some cases, the wristband system may have a split architecture that allows the watch band and the watch body to operate both independently and in communication with one another. The mechanical architecture may include a coupling mechanism on the watch band and/or the watch body that allows a user to conveniently attach and detach the watch body from the watch band.

The wristband system of FIGS. 1A and 1B, for example, may be used in isolation or in conjunction with other systems including artificial-reality (AR) systems. Sensors of the wristband system (e.g., image sensors, inertial measurement units (IMUs), etc.) may be used, for example, to enhance an AR application running on the AR system. Further, the watch band may include sensors that measure biometrics of the user. For example, the watch band may include neuromuscular sensors disposed on an inside surface of the watch band contacting the user that detects the muscle intentions of the user. The AR system may include a head-mounted display that is configured to enhance a user interaction with an object within the AR environment based on the muscle intentions of the user. Signals sensed by the neuromuscular sensors may be processed and used to provide a user with an enhanced interaction with a physical object and/or a virtual object in an AR environment. For example, the AR system may operate in conjunction with the neuromuscular sensors to overlay one or more visual indicators on or near an object within the AR environment such that the user could perform “enhanced” or “augmented” interactions with the object.

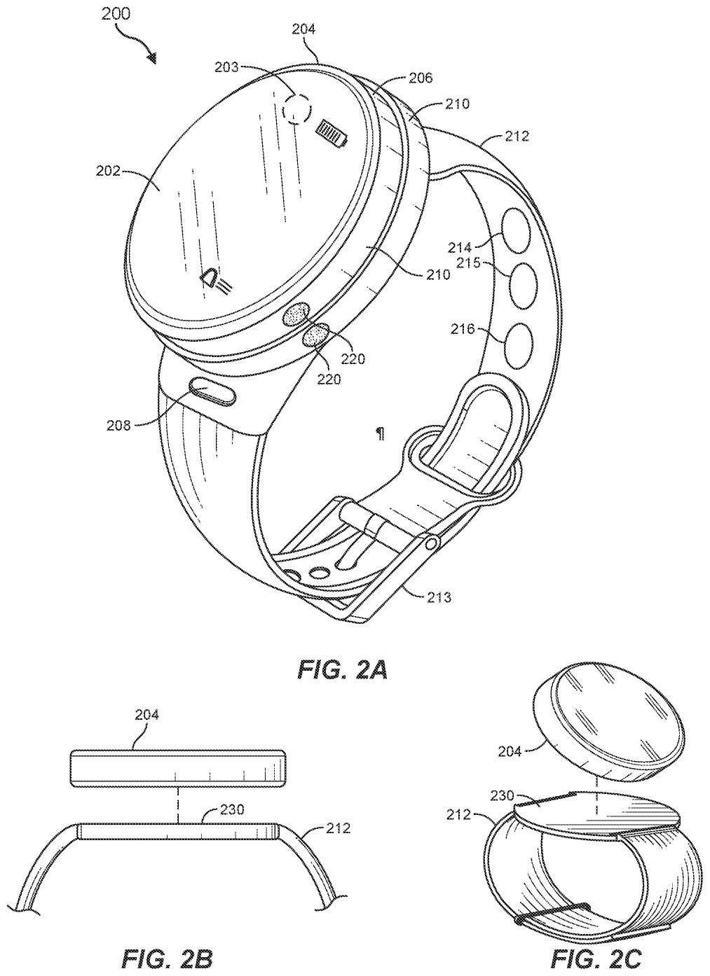

FIGS. 1A and 1B illustrate an embodiment of a wristband system including a watch band and a watch body. In some cases, neuromuscular sensors may be integrated within the wristband system, as shown in FIGS. 2A, 2B, and 2C. FIG. 1A illustrates an example wristband system 100 that includes a watch body 104 coupled to a watch band 112. Watch body 104 and watch band 112 may have any size and/or shape that is configured to allow a user to wear wristband system 100 on a body part (e.g., a wrist). Wristband system 100 may include a retaining mechanism 113 (e.g., a buckle) for securing watch band 112 to the user's wrist. Wristband system 100 may also include a coupling mechanism 106, 110 for detachably coupling watch body 104 to watch band 112. Still further, the wristband system 100 may include a button or wheel 108 that allows users to interact with the wristband system 100 including applications that run on the system.

Wristband system 100 may perform various functions associated with the user. The functions may be executed independently in watch body 104, independently in watch band 112, and/or in communication between watch body 104 and watch band 112. Watch band 112 and its associated antennas may be configured to operate independently (e.g., execute functions independently) from watch body 104. Additionally or alternatively, watch body 104 and its associated antennas may be configured to operate independently (e.g., execute functions independently) from watch band 112. At least in some cases, watch band 112 and/or watch body 104 may each include the independent resources required to independently execute functions. For example, watch band 112 and/or watch body 104 may each include a power source (e.g., a battery), a memory, data storage, a processor (e.g., a CPU), communications (including multiple different types of antennas), a light source (e.g., at least one infrared LED for tracking watch body 104 and/or watch band 112 in space with an external sensor), and/or input/output devices.

FIG. 1B illustrates an example wristband system 100 that includes a watch body 104 decoupled from a watch band 112. Watch band 112 may be donned (e.g., worn) on a body part (e.g., a wrist) of a user and may operate independently from watch body 104. For example, watch band 112 may be configured to be worn by a user and an inner surface of watch band 112 may be in contact with the user's skin. When worn by a user, sensor 114 may be in contact with the user's skin. Sensor 114 may be a biosensor that senses a user's heart rate, bioimpedance, saturated oxygen level, temperature, sweat level, muscle intentions, steps taken, or a combination thereof. Watch band 112 may include multiple sensors 114 and 116 that may be distributed on an inside surface, in an interior volume, and/or on an outside surface of watch band 112. In some examples, watch body 104 may include an electrical connector 118 that mates with connector 120 of watch band 112 for wired communication and/or power transfer. In some examples, as will be described further below, watch body 104 and/or watch band 112 may include wireless communication devices including LTE antennas, GPS antennas, Bluetooth antennas, WiFi antennas, NFC antennas, or other types of antennas.

Wristband system 100 may include a coupling mechanism for detachably coupling watch body 104 to watch band 112. A user may detach watch body 104 from watch band 112 in order to reduce the encumbrance of wristband system 100 to the user. Detaching watch body 104 from watch band 112 may reduce a physical profile and/or a weight of wristband system 100. Wristband system 100 may include a watch body coupling mechanism(s) 106 and/or a watch band coupling mechanism(s) 110. A user may perform any type of motion to couple watch body 104 to watch band 112 and to decouple watch body 104 from watch band 112. For example, a user may twist, slide, turn, push, pull, or rotate watch body 104 relative to watch band 112, or a combination thereof, to attach watch body 104 to watch band 112 and to detach watch body 104 from watch band 112.

As illustrated in FIG. 1B, in some examples, watch body 104 may include front-facing image sensor 115A and rear-facing image sensor 115B. Front-facing image sensor 115A may be located in a front face of watch body 104 (e.g., substantially near, under, or on the display 102), and rear-facing image sensor 115B may be located in a rear face of watch body 104. In some examples, a level of functionality of at least one of watch band 112 or watch body 104 may be modified when watch body 104 is detached from watch band 112. The level of functionality that may be modified may include the functionality of front-facing image sensor 115A and/or rear-facing image sensor 115B. Alternatively, the level of functionality may be modified to change how the various antennas within the system. For instance, as will be described further below, the embodiments herein may include a cosmetic RF transparent feature that may form a functional link between wrist strap antennas and internal electronic components including tuners, amplifiers, controllers, and data processors.

FIG. 2A illustrates a perspective view of an example wristband system 200 that includes a watch body 204 decoupled from a watch band 212. Wristband system 200 may be structured and/or function similarly to wristband system 100 of FIGS. 1A and 1B. Watch body 204 and watch band 212 may have a substantially rectangular or circular shape and may be configured to allow a user to wear wristband system 200 on a body part (e.g., a wrist). Wristband system 200 may include a retaining mechanism 213 (e.g., a buckle, a hook and loop fastener, etc.) for securing watch band 212 to the user's wrist. Wristband system 200 may also include a coupling mechanism 208 for detachably coupling watch body 204 to watch band 212. The watch body 204 may include an enclosure 206 that houses various electronic components. In some cases, the watch body 204 may be referred to as a “capsule.”

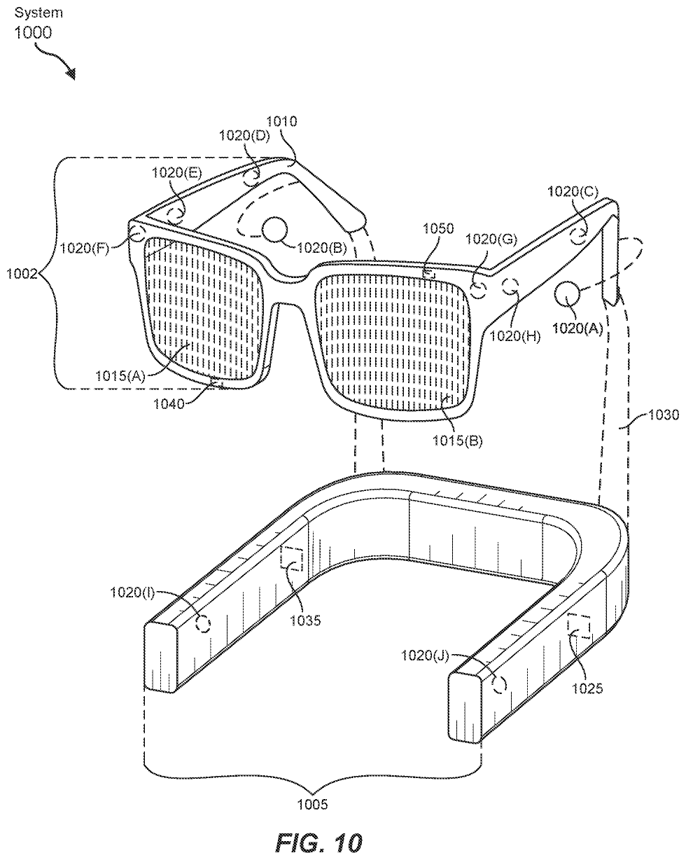

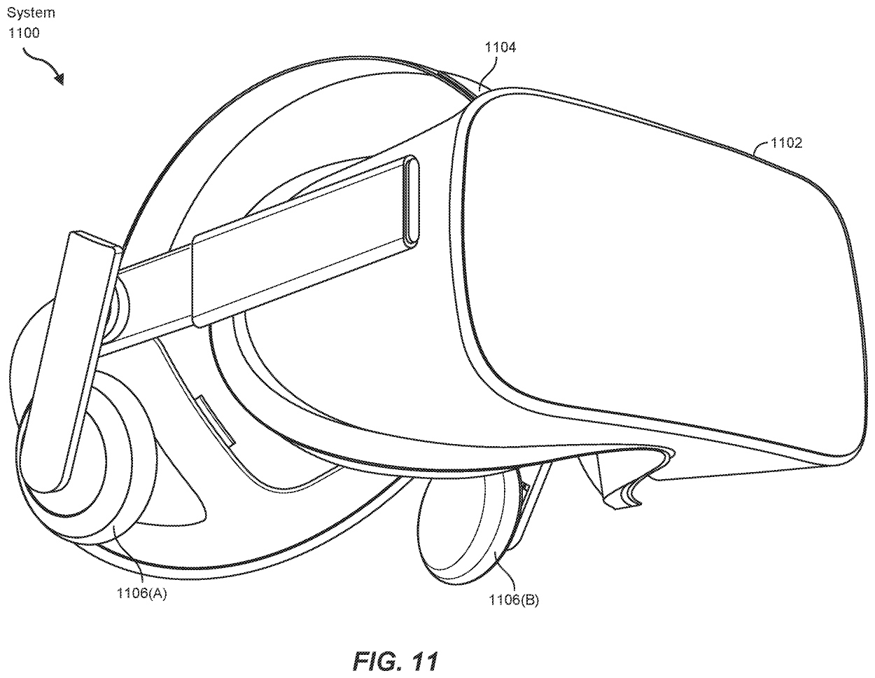

Wristband system 200 may perform various functions associated with the user as described above with reference to FIGS. 1A and 1B. The functions executed by wristband system 200 may include, without limitation, display of visual content to the user (e.g., visual content displayed on display screen 202), sensing user input (e.g., sensing a touch on a touch bezel 210 or on a physical button, sensing biometric data on sensor 214, sensing neuromuscular signals on neuromuscular sensors 215 or 216, sensing audio input via microphones 220, etc.), messaging (e.g., text, speech, video, etc.), image capture (e.g., with a front-facing image sensor 203 and/or a rear-facing image sensor), wireless communications (e.g., cellular, near field, WiFi, personal area network, etc.), location determination, financial transactions, providing haptic feedback, alarms, notifications, biometric authentication, health monitoring, sleep monitoring, etc. These functions may be executed independently in watch body 204, independently in watch band 212, and/or in communication between watch body 204 and watch band 212. Functions may be executed on wristband system 200 in conjunction with an artificial-reality system such as the artificial-reality systems described in FIGS. 10 and 11.

Watch band 212 may be configured to be worn by a user such that an inner surface of watch band 212 may be in contact with the user's skin. When worn by a user, sensor 214 may be in contact with the user's skin. Sensor 214 may be a biosensor that senses a user's heart rate, saturated oxygen level, temperature, sweat level, muscle intentions, or a combination thereof. Watch band 212 may include multiple sensors 214 that may be distributed on an inside and/or an outside surface of watch band 212. Additionally or alternatively, watch body 204 may include the same or different sensors than watch band 212. For example, multiple sensors may be distributed on an inside and/or an outside surface of watch body 204 or on the surface of the wrist straps. The watch body 204 may include, without limitation, front-facing image sensor 115A, rear-facing image sensor 115B, a biometric sensor, an IMU, a heart rate sensor, a saturated oxygen sensor, a neuromuscular sensor(s), an altimeter sensor, a temperature sensor, a bioimpedance sensor, a pedometer sensor, an optical sensor, a touch sensor, a sweat sensor, etc.

Watch band 212 may transmit the data acquired by sensor 214 to watch body 204 using a wired communication method (e.g., a UART, a USB transceiver, etc.) and/or a wireless communication method (e.g., near field communication, Bluetooth™, etc.). Watch band 212 may be configured to operate (e.g., to collect data using sensor 214) independent of whether watch body 204 is coupled to or decoupled from watch band 212. In some examples, watch band 212 may include a neuromuscular sensor 215 (e.g., an electromyography (EMG) sensor, a mechanomyogram (MMG) sensor, a sonomyography (SMG) sensor, etc.). Neuromuscular sensor 215 may sense a user's muscle intention.

FIG. 2B is a side view and FIG. 2C is a perspective view of another example wristband system. The wristband systems of FIGS. 2B and 2C may include a watch body interface 230 or “cradle.” Watch body 204 may be detachably coupled to watch body interface 230. In additional examples, one or more electronic components may be housed in watch body interface 230 and one or more other electronic components may be housed in portions of watch band 212 away from watch body interface 230.

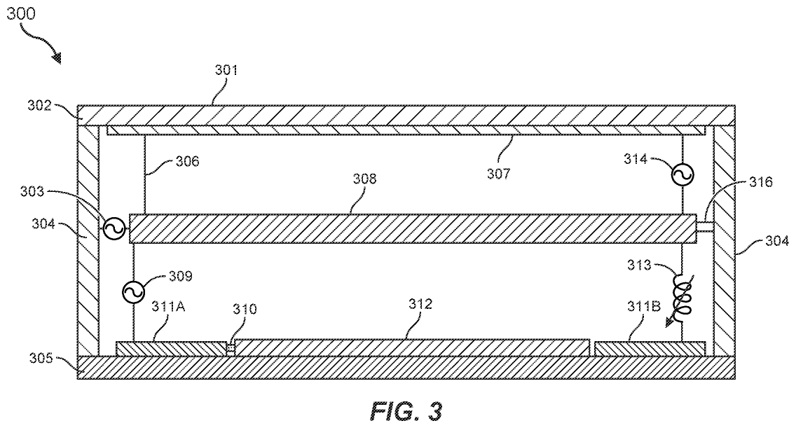

The following will provide, with reference to FIGS. 3-11, detailed descriptions of systems and wearable electronic devices that implement different antenna architectures in different scenarios. Features from any of the embodiments described herein may be used in combination with one another in accordance with the general principles described herein. These and other embodiments, features, and advantages will be more fully understood upon reading the following detailed description in conjunction with the accompanying drawings and claims.

FIG. 3 illustrates an embodiment of a system 300 that may include multiple different antennas. The system 300 may be a mobile electronic device or may be a portion of an electronic device. In some examples, the system 300 may be a bezel or capsule portion of a smartwatch. As noted above, this capsule may be detachable from a cradle device that is designed to receive and hold the capsule. In other cases, it should be noted, the antenna architectures and embodiments described herein may be applied to other mobile devices including augmented reality devices (e.g., as shown in FIG. 10), virtual reality devices (e.g., as shown in FIG. 11), smartphones, tablets, Internet of Things devices, wearable electronic devices, gaming devices, or other electronic devices.

The system 300 may include an enclosure 304. The enclosure may be metallic, or may be made of another type of conductive material (e.g., conductive polymer). The enclosure may be conductive over its entirety, or may be conductive only in certain portions. In some cases, the system 300 may include a bottom cover portion 305 that is made of plastic or other nonconductive material. This bottom cover portion 305 may attach to the conductive enclosure 304, and may include apertures for the various sensors that may be part of the sensor PCB 312. The system 300 may include a display 302 such as a touchscreen organic light emitting diode (OLED) display or other type of display. Users may interact with the display 302 via a touch-sensitive surface 301. A display shield 307 may be positioned beneath the display 302. This display shield 307 may include a copper foil or other electromagnetic shielding material. The display shield 307 may shield other internal electronic components from the display 302 and may preserve antenna efficiency for the antennas below the display.

The system 300 may further include a main logic board or PCB 308. The PCB 308 may include multiple different electronic components affixed thereto. For instance, an LTE mid/high band antenna feed 303 may be housed on the PCB 308. The LTE mid/high band antenna feed 303 may additionally include GPS. In some cases, the LTE mid/high band antenna feed 303 may be electrically connected to the conductive enclosure 304 and use the conductive enclosure as a radiating element. Still further, the PCB 308 may include an LTE low band antenna feed 309. This LTE low band antenna feed may be electrically connected to a conductive substrate 311A. This conductive substrate 311A may include conductive channels etched into the substrate using laser direct structuring (LDS) or other similar methods. In some cases, the LTE low band antenna 309 may be tuned using the tuner 313, which is electrically connected to a different portion of conductive substrate 311B. The PCB 308 may be grounded to the conductive enclosure 304 via an electrical ground connection 316.

In some cases, batteries, data storage modules, sensors, or other components may be positioned either between the PCB 308 and the display 302 or between the PCB 308 and the lower PCB 312 (alternatively referred to herein as the “sensor PCB” since PCB 312 may often (but not always) include sensors). It will be recognized that the system 300 may include substantially any number of different electronic and/or mechanical components, not all of which are shown in FIG. 3. In system 300, three antennas are shown, although more or fewer antennas may be used. In some embodiments, an LTE low band antenna feed may be electrically connected to the sensor PCB 312, an LTE mid/high band/GPS antenna feed may be electrically connected to the conductive enclosure 304, and a WiFi/UWB antenna feed may be electrically connected to the display shield 307. Within this system, the sensor PCB 312 may have heart rate and other sensors, and may operate as a radiating element of an LTE low band antenna.

In at least some embodiments, the grounding layer or ground plane of the sensor board 312 may operate as the radiating element of the LTE low band antenna 309. The LTE low band antenna may connect to the sensor board 312 via an electrical connection 310, and may operate between 600 MHz-900 MHz. In some cases, the conductive enclosure 304 may operate as a radiating element of the LTE mid/high band and/or GPS antenna. The mid/high band antenna may operate between 1.575 GHz-2.7 GHz. Still further, at least in some cases, the display shield may operate as the radiating element of the WiFi/UWB/Bluetooth high frequency antenna. The antenna may be an ultrahigh band antenna, operating between 2.4 GHz-10.6 GHz (or higher). These three antennas may be positioned in a manner that takes into account their operating conditions. For instance, because the LTE low band antenna operates below 1 GHz, the LTE low band antenna may be placed near the bottom of the device, next to the wearer's wrist.

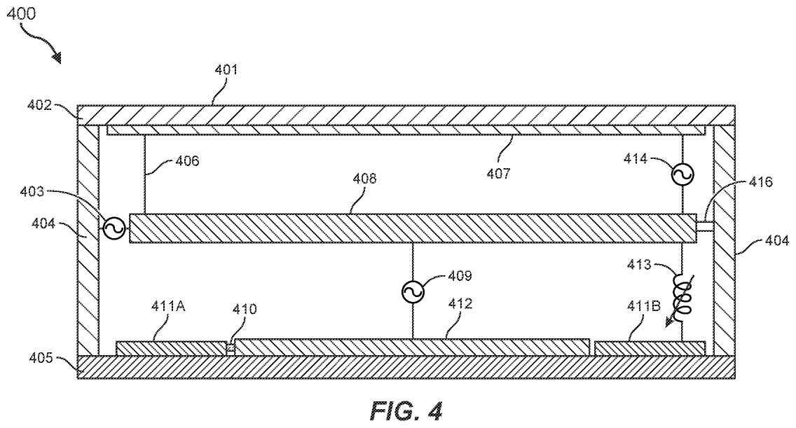

Moreover, instead of implementing separate hardware and taking up additional space in the mobile device, the embodiments herein may implement the grounding layer and/or conducive traces of the sensor PCB 312 as a radiating element. In this manner, the space already used for the sensor PCB 312 may be implemented for antenna transmission and reception. In the embodiment of FIG. 3, the LTE low band feed 309 may be connected through a conductive substrate to the sensor PCB 312, while in other cases, as will be discussed in regard to FIG. 4, the LTE low band feed may be connected directly from the main PCB 308 to the grounding layer of the sensor PCB 312.

The LTE mid/high band GPS antenna 303 may lie farther away from the wearer's wrist. For instance, the LTE mid/high band GPS antenna 303 may be separated from the user's body by the back cover 305, the sensor PCB 312, and other intermediary components such as batteries. The LTE mid/high band GPS antenna 303 may implement the conductive outer enclosure 304 as a radiating element, either wholly or partially (e.g., one side or another side if a separating nonconductive gap is used). The conductive outer enclosure 304 may be the outermost surface of the mobile device and, as such, may experience less absorption by the wearer's arm. At least in some cases, the conductive outer enclosure 304 may be particularly suited to operation at 1.575 GHz-2.7 GHz.

Still further, the WiFi/UWB/Bluetooth antenna 314 may be positioned furthest from the wearer's wrist. The WiFi/UWB/Bluetooth antenna 314 may implement the conductive display shield 307 as its radiating element. The display shield 307 may be relatively far away from the sensor board 312, the main PCB 308, and other intermediary components. Moreover, because ultra-high frequencies such as 2.4 GHz-10.6 GHz may be more likely to be absorbed by a user's body, this antenna may implement a display shield 307 as a radiating element that lies at the topmost portion of the mobile device, only being positioned below the user-facing display 302. As such, this antenna may implement the structurally highest possible conductive component in the mobile device as its radiating element.

FIG. 4 illustrates an embodiment of a mobile electronic device 400 that may include a direct connection between a main logic board and a sensor board. For instance, mobile electronic device 400 may include a main PCB 408. This main PCB 408 may include multiple antenna feeds for different antennas and, particularly, antennas designed to operate within different frequency ranges. In one embodiment, an LTE low band antenna feed 409 may be electrically connected directly from the main PCB 408 to the sensor PCB 412. In such an embodiment, the LTE low band antenna feed 409 may be electrically connected to a grounding layer of the sensor PCB 412 and may use the grounding layer as an operative, radiating element. The mobile electronic device 400 may implement a low band tuner 413 to tune the low band antenna. This tuner may be connected to a conductive substrate 411B that is electrically connected to the sensor PCB 412. In some cases, the conductive substrate 411A may be omitted from the mobile device, or may be used to connect different components.

The main PCB 408 may also include an LTE mid/high band/GPS antenna feed 403 that is electrically connected to the conductive enclosure 404. As such, the LTE mid/high band/GPS antenna feed 403 may use the conductive enclosure as a radiating element. The conductive enclosure 404 may be affixed to a nonconductive back cover 405 that lies in contact with the wearer's wrist. The conductive enclosure 404 may also be affixed to a display 402 such as a touchscreen display that allows users to interact with the mobile device using a touch-sensitive display surface 401. The main PCB 408 may also include an ultrahigh band antenna feed 414 (e.g., WiFi/UWB/Bluetooth). The ultrahigh band antenna feed 414 may be electrically connected to a display shield 407. The display shield 407 may be designed to protect the display, as well as structurally lower components, from electromagnetic interference. The display shield 407 may be a copper sheet or other conductive element designed to shield the display. In the embodiments herein, the ultrahigh band antenna 414 may implement the display shield 407 as a radiating element. The main PCB 408 may be grounded to the display shield at grounding point 406 and/or at grounding point 416. These grounding points may be implemented to tune the various antennas.

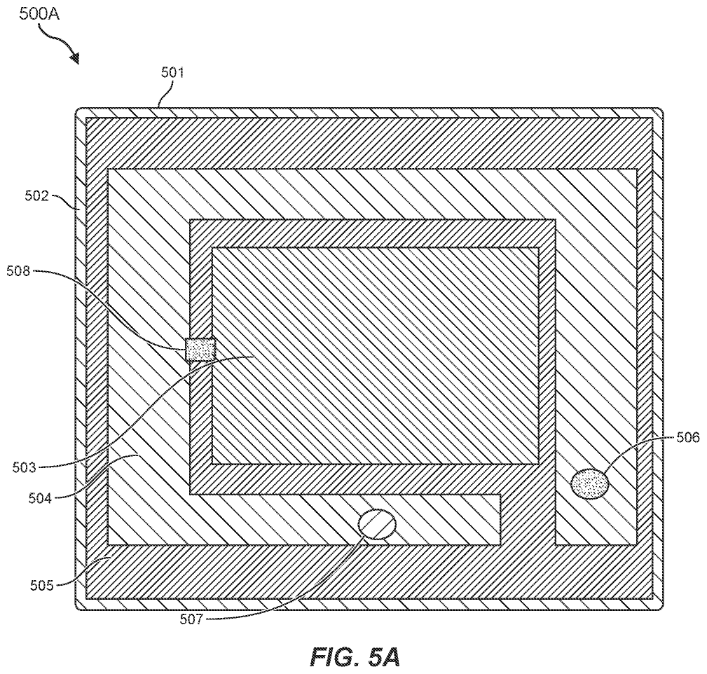

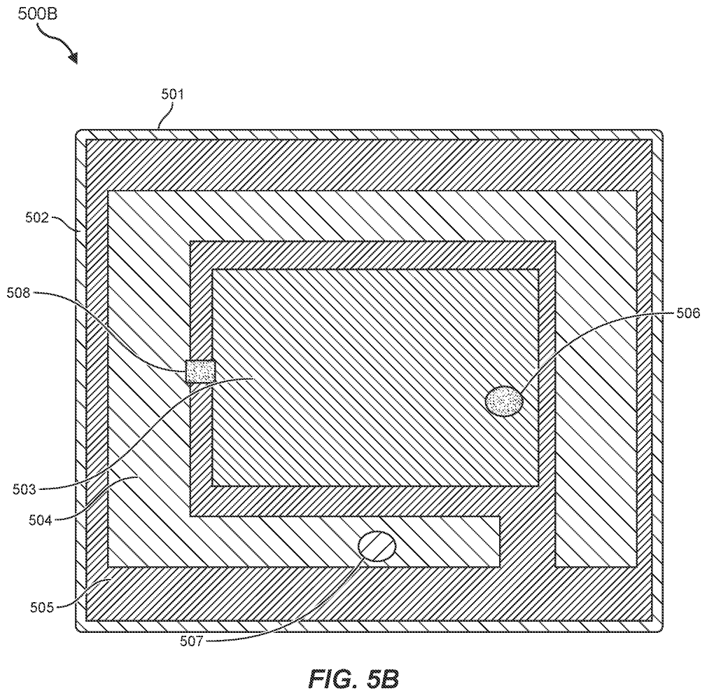

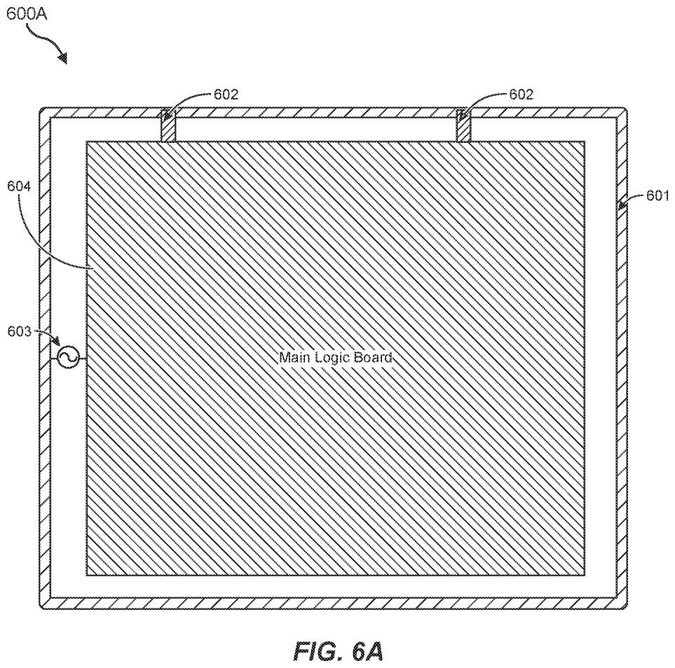

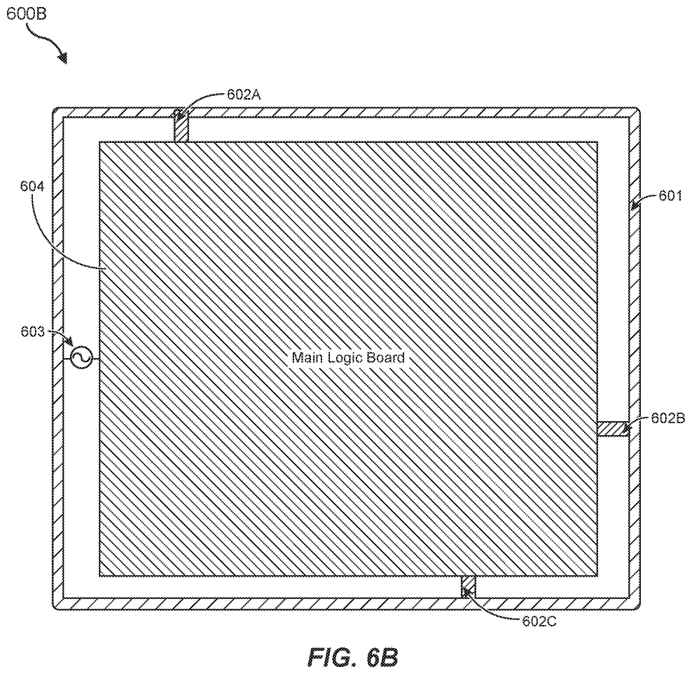

FIGS. 5A and 5B illustrate embodiments in which an LTE low band antenna feed (e.g., 506) may be connected to different portions of a mobile device 501. Embodiments 500A and 500B of FIGS. 5A and 5B illustrate top views of an LTE low band antenna on positioned near or on the back cover 505 of the device. Thus, in FIG. 5A, the LTE low band antenna feed 506 (e.g., an LTE low band feed) may be positioned on an antenna area on the inner surface 504 of the bottom cover 505. The antenna area on the inner surface 504 may include a conductive substrate that may include traces or conductive paths etched using laser direct structuring. The antenna area may be connected to the sensor PCB 503 via an electrical connection 508. In some embodiments, a tuner 507 for the LTE low band antenna may also be connected to the same or a different portion of conductive substrate (e.g., 504). Each of these components may be housed in a conductive enclosure 502. In the alternative embodiment of FIG. 5B, the LTE low band antenna feed 506 may be connected directly to the sensor PCB 503 instead of through the conductive substrate.

As noted above, the various antennas may be grounded or fed in different manners that may allow for different tunings. For instance, LTE low band, LTE mid/high band/GPS, or ultrahigh band antennas may be tuned to higher or lower frequencies within their operable range. For example, a given mobile electronic device may include different antennas and internal electronic components. A mobile device may include, for example, a main logic board (MLB) that includes various antenna feeds. For instance, as shown in embodiment 600A of FIG. 6A, a main logic board 604 may include an antenna feed 603, along with two grounding points 602. In this embodiment, the grounding points 602 may ground the main logic board 604 to the mobile device's conductive enclosure 601.

In other embodiments, different grounding points may be used to ground to a display shield or to other positions on the conductive enclosure 601. In some embodiments, the mobile device may include other printed circuit boards, such as a sensor board with one or more sensors placed thereon. In such cases, one antenna feed (e.g., 603) may be electrically connected to the conductive enclosure 601, and another antenna feed may be electrically connected to a grounding layer of the sensor board. In this example, the grounding layer of the sensor board may act as a radiating element, while the conductive enclosure 601 acts as the radiating element for LTE middle/high band/GPS antenna. Each of the antennas may operate at different frequencies or within different frequency bands. In some cases, as shown in embodiment 600B of FIG. 6B, different grounding elements may be placed in different positions in order to tune one or more of the antennas.

For instance, in FIG. 6B, a main logic board 604 may include three grounding connections at which the main logic board 604 is grounded to the conductive enclosure 601: grounding point 602A on the top side, grounding point 602B on the right side, and grounding point 602C on the bottom side. More or fewer grounding points may be used, and each may be positioned at different locations. This may apply whether the grounding connections are between the main logic board 604 and a display shield (not shown in FIG. 6B), between the main logic board 604 and the conductive enclosure, or between the main logic board 604 and a sensor PCB (not shown). Still further, antenna feeds (e.g., 603) may also be repositioned in different locations relative to the conductive enclosure 601 or relative to the display shield or the sensor PCB. Positioning the antenna feed in a different location may also affect the resonating properties of the antenna and, as such, may be taken into account to optimize each antenna feed's location.

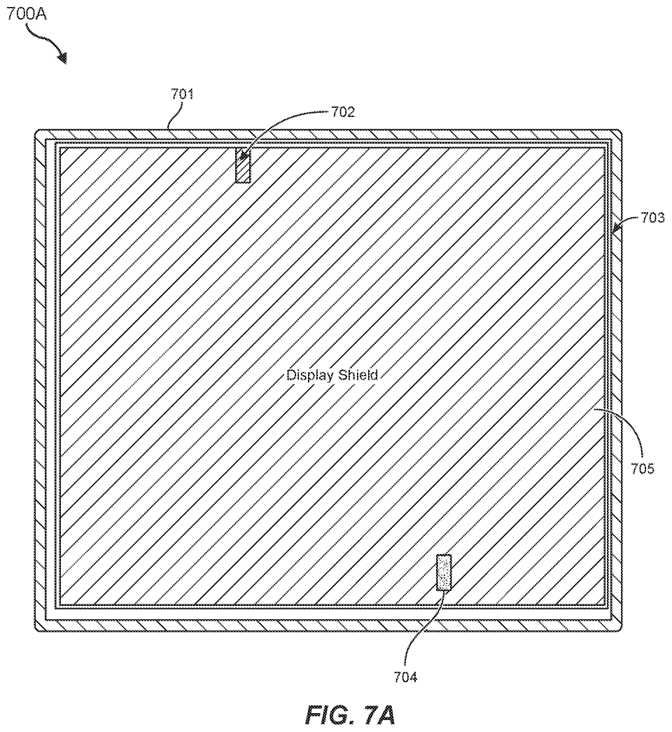

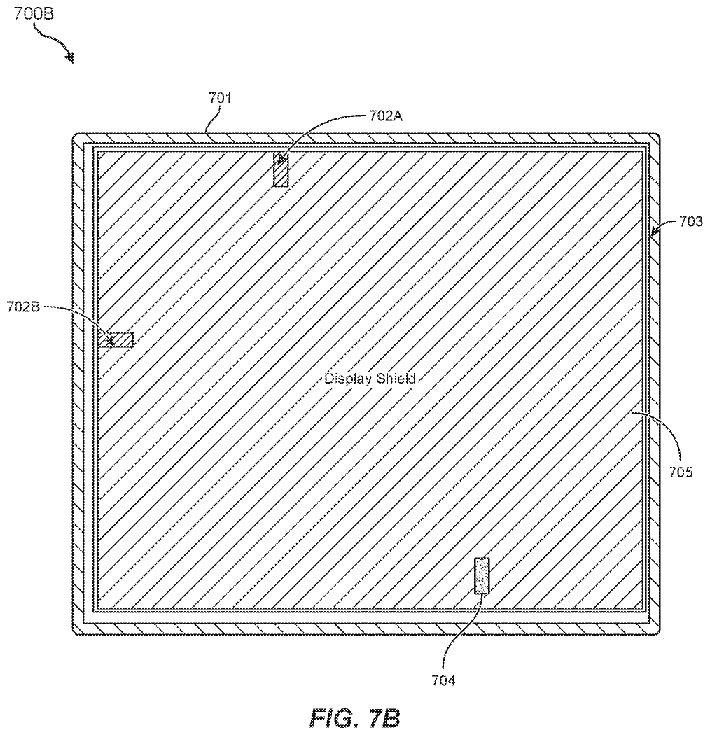

FIGS. 7A and 7B illustrate embodiments of a bottom view of a display shield 705. The display shield 705 in embodiment 700A of FIG. 7A may include an antenna feed 704 electrically connected thereto, as well as a grounding connection 702 to the main logic board of the underlying mobile device 701. The display shield may also be driven by the antenna feed 704 and, as such, may radiate at a specific frequency or at different frequencies within a given band. For instance, the antenna feed driving the display shield 705 may be a WiFi feed, a UWB feed, a Bluetooth feed, or some other ultrahigh band antenna feed. The display shield 705 may then radiate at that frequency. In some cases, as shown in embodiment 700B of FIG. 7B, different number of grounding connections may be used, and those grounding connections (e.g., 702A and 702B) may be implemented at different locations to tune the radiation frequency of the display shield 705.

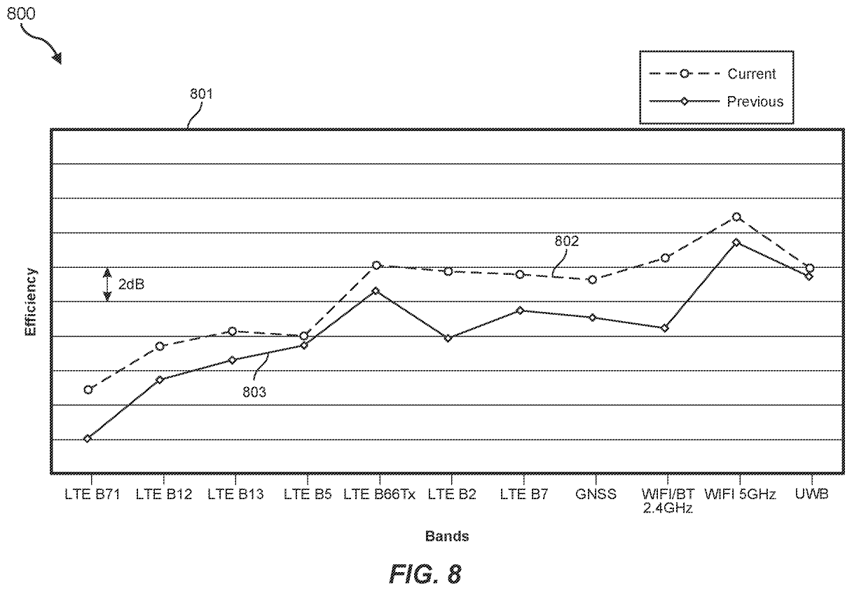

Chart 801 of FIG. 8 illustrates a simulation in which the embodiments described herein are compared to other mobile devices with different antenna designs. In chart 801, it can be seen that, over a broad range of frequencies, the antenna designs described herein are superior to other previous designs. And, especially at certain frequencies (e.g., LTE B2, LTE B7, GNSS, WiFi/BT), the antenna efficiency 802 of the embodiments described herein may be two (or more) dB better than the efficiency 803 of previous designs. This efficiency may derive from the strategic placement of LTE low band antennas near the user's body, LTE mid/high band/GPS antennas in central positions that use the conductive enclosure as a radiating element, and ultrahigh band antennas near the top of the device (e.g., near the display of a smartwatch). By using the display shield, conductive enclosure, and sensor PCB grounding layer as radiating elements, the embodiments herein may experience much less absorption by a user's body, much less internal interference from other components, and a much greater transmitting and receiving efficiency due to each antenna's strategic placement within the device.

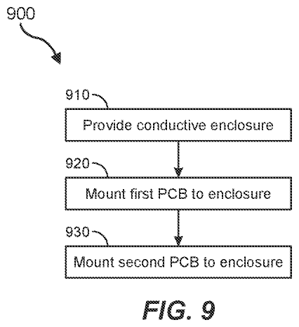

FIG. 9 is a flow diagram of a method of manufacturing for providing, forming, creating, or otherwise generating a mobile device that includes one or more of the antenna architectures described herein. The steps shown in FIG. 9 may be performed by any suitable manufacturing equipment, including 3D printers, and may be controlled via computer-executable code and/or networked computing systems. In one example, each of the steps shown in FIG. 9 may represent an algorithm whose structure includes and/or is represented by multiple sub-steps, examples of which will be provided in greater detail below.

The method of manufacturing 900 of FIG. 9 may include, at step 910, providing a conductive enclosure (e.g., 304 of FIG. 3). Such a conductive enclosure may be manufactured from a conductive metal or alloy, from conductive polymers, or from some other type of conductive material. Step 920 of method 900 may include mounting, to the conductive enclosure, a first printed circuit board (PCB) (e.g., 308) that includes multiple antenna feeds (e.g., 303, 309, and/or 314). Step 920 of method 900 may include mounting, to the enclosure, a second PCB (e.g., sensor PCB 312) that includes a grounding layer and various sensors.

In some cases, the method of manufacturing 900 may be implemented to produce a mobile electronic device. Such a mobile device may include a conductive enclosure, a first printed circuit board (PCB) that includes various antenna feeds, and a second PCB that includes a grounding layer and sensors. Within this mobile device, a first antenna feed may be electrically connected to the conductive enclosure, and a second antenna feed may be electrically connected to the grounding layer of the second PCB, so that the grounding layer of the second PCB acts as a radiating element for a second antenna.

In some embodiments, the mobile electronic device may include a display shield that includes conductive material configured to electrically shield a display from different internal electronic components mounted to the first PCB. In some cases, a third antenna feed may be electrically connected to the display shield, so that the display shield acts as a radiating element for a third antenna. The mobile device may be manufactured in such a manner that each of the three antennas (and potentially others) may operate within different frequency bands. Any of the embodiments and antenna designs described herein may be implemented in a smartwatch, a smartphone, an internet of things (IoT) device, a pair of augmented reality glasses, a virtual reality headset, or other type of mobile electronic device.

### EXAMPLE EMBODIMENTS

Example 1: A system may include a conductive enclosure, a first printed circuit board (PCB) that includes a plurality of antenna feeds, and a second PCB that includes a grounding layer and one or more sensors, wherein a first antenna feed of the plurality of antenna feeds is electrically connected to the conductive enclosure, and wherein a second antenna feed of the plurality of antenna feeds is electrically connected to the grounding layer of the second PCB, such that the grounding layer of the second PCB acts as a radiating element for a second antenna.

Example 2: The system of Example 1, further comprising a display shield that includes conductive material configured to electrically shield a display from one or more internal electronic components mounted to the first PCB.

Example 3: The system of Example 1 or Example 2, wherein a third antenna feed of the plurality of antenna feeds is electrically connected to the display shield, such that the display shield acts as a radiating element for a third antenna.

Example 4: The system of any of Examples 1-3, wherein the first, second, and third antenna feeds each operate within different frequency bands.

Example 5: The system of any of Examples 1-4, wherein the third antenna feed electrically connected to the display shield comprises an ultrahigh band antenna.

Example 6: The system of any of Examples 1-5, wherein the first antenna feed electrically connected to the conductive enclosure comprises a low band cellular antenna.

Example 7: The system of any of Examples 1-6, wherein the second antenna feed electrically connected to the grounding layer of the second PCB comprises a mid-high band cellular antenna.

Example 8: The system of any of Examples 1-7, wherein the second antenna feed is electrically connected to a conductive portion of a substrate that is electrically connected to the second PCB.

Example 9: The system of any of Examples 1-8, further comprising one or more grounding connections between the first PCB and the conductive enclosure.

Example 10: The system of any of Examples 1-9, further comprising one or more grounding connections between the first PCB and the display shield.

Example 11: The system of any of Examples 1-10, further comprising a nonconductive bottom cover attached to the conductive enclosure, wherein the second PCB is affixed to the nonconductive bottom cover.

Example 12: A mobile electronic device may include a conductive enclosure, a first printed circuit board (PCB) that includes a plurality of antenna feeds, and a second PCB that includes a grounding layer and one or more sensors, wherein a first antenna feed of the plurality of antenna feeds is electrically connected to the conductive enclosure, and wherein a second antenna feed of the plurality of antenna feeds is electrically connected to the grounding layer of the second PCB, such that the grounding layer of the second PCB acts as a radiating element for a second antenna.

Example 13: The mobile electronic device of Example 12, further comprising a display shield that includes conductive material configured to electrically shield a display from one or more internal electronic components mounted to the first PCB.

Example 14: The mobile electronic device of Example 12 or Example 13, wherein a third antenna feed of the plurality of antenna feeds is electrically connected to the display shield, such that the display shield acts as a radiating element for a third antenna.

Example 15: The mobile electronic device of any of Examples 12-14, wherein the first, second, and third antenna feeds each operate within different frequency bands.

Example 16: The mobile electronic device of any of Examples 12-15, wherein the second antenna feed is electrically connected to a conductive portion of a substrate that is electrically connected to the second PCB.

Example 17: The mobile electronic device of any of Examples 12-16, further comprising one or more grounding connections between the first PCB and the conductive enclosure.

Example 18: The mobile electronic device of any of Examples 12-17, further comprising a nonconductive bottom cover attached to the conductive enclosure, wherein the second PCB is affixed to the nonconductive bottom cover.

Example 19: The mobile electronic device of any of Examples 12-18, wherein the mobile electronic device comprises at least one of a smartwatch, a smartphone, an internet of things (IoT) device, a pair of augmented reality glasses, or a virtual reality headset.

Example 20: A method of manufacturing may include providing a conductive enclosure, mounting, to the conductive enclosure, a first printed circuit board (PCB) that includes a plurality of antenna feeds, and mounting, to the enclosure, a second PCB that includes a grounding layer and one or more sensors, wherein a first antenna feed of the plurality of antenna feeds is electrically connected to the conductive enclosure, and wherein a second antenna feed of the plurality of antenna feeds is electrically connected to the grounding layer of the second PCB, such that the grounding layer of the second PCB acts as a radiating element for a second antenna.

Embodiments of the present disclosure may include or be implemented in conjunction with various types of artificial-reality systems. Artificial reality is a form of reality that has been adjusted in some manner before presentation to a user, which may include, for example, a virtual reality, an augmented reality, a mixed reality, a hybrid reality, or some combination and/or derivative thereof. Artificial-reality content may include completely computer-generated content or computer-generated content combined with captured (e.g., real-world) content. The artificial-reality content may include video, audio, haptic feedback, or some combination thereof, any of which may be presented in a single channel or in multiple channels (such as stereo video that produces a three-dimensional (3D) effect to the viewer). Additionally, in some embodiments, artificial reality may also be associated with applications, products, accessories, services, or some combination thereof, that are used to, for example, create content in an artificial reality and/or are otherwise used in (e.g., to perform activities in) an artificial reality.

Artificial-reality systems may be implemented in a variety of different form factors and configurations. Some artificial-reality systems may be designed to work without near-eye displays (NEDs). Other artificial-reality systems may include an NED that also provides visibility into the real world (such as, e.g., augmented-reality system 1000 in FIG. 10) or that visually immerses a user in an artificial reality (such as, e.g., virtual-reality system 1100 in FIG. 11). While some artificial-reality devices may be self-contained systems, other artificial-reality devices may communicate and/or coordinate with external devices to provide an artificial-reality experience to a user. Examples of such external devices include handheld controllers, mobile devices, desktop computers, devices worn by a user, devices worn by one or more other users, and/or any other suitable external system.

Turning to FIG. 10, augmented-reality system 1000 may include an eyewear device 1002 with a frame 1010 configured to hold a left display device 1015(A) and a right display device 1015(B) in front of a user's eyes. Display devices 1015(A) and 1015(B) may act together or independently to present an image or series of images to a user. While augmented-reality system 1000 includes two displays, embodiments of this disclosure may be implemented in augmented-reality systems with a single NED or more than two NEDs.

In some embodiments, augmented-reality system 1000 may include one or more sensors, such as sensor 1040. Sensor 1040 may generate measurement signals in response to motion of augmented-reality system 1000 and may be located on substantially any portion of frame 1010. Sensor 1040 may represent one or more of a variety of different sensing mechanisms, such as a position sensor, an inertial measurement unit (IMU), a depth camera assembly, a structured light emitter and/or detector, or any combination thereof. In some embodiments, augmented-reality system 1000 may or may not include sensor 1040 or may include more than one sensor. In embodiments in which sensor 1040 includes an IMU, the IMU may generate calibration data based on measurement signals from sensor 1040. Examples of sensor 1040 may include, without limitation, accelerometers, gyroscopes, magnetometers, other suitable types of sensors that detect motion, sensors used for error correction of the IMU, or some combination thereof.

In some examples, augmented-reality system 1000 may also include a microphone array with a plurality of acoustic transducers 1020(A)-1020(J), referred to collectively as acoustic transducers 1020. Acoustic transducers 1020 may represent transducers that detect air pressure variations induced by sound waves. Each acoustic transducer 1020 may be configured to detect sound and convert the detected sound into an electronic format (e.g., an analog or digital format). The microphone array in FIG. 10 may include, for example, ten acoustic transducers: 1020(A) and 1020(B), which may be designed to be placed inside a corresponding ear of the user, acoustic transducers 1020(C), 1020(D), 1020(E), 1020(F), 1020(G), and 1020(H), which may be positioned at various locations on frame 1010, and/or acoustic transducers 1020(I) and 1020(J), which may be positioned on a corresponding neckband 1005.

In some embodiments, one or more of acoustic transducers 1020(A)-(J) may be used as output transducers (e.g., speakers). For example, acoustic transducers 1020(A) and/or 1020(B) may be earbuds or any other suitable type of headphone or speaker.

The configuration of acoustic transducers 1020 of the microphone array may vary. While augmented-reality system 1000 is shown in FIG. 10 as having ten acoustic transducers 1020, the number of acoustic transducers 1020 may be greater or less than ten. In some embodiments, using higher numbers of acoustic transducers 1020 may increase the amount of audio information collected and/or the sensitivity and accuracy of the audio information. In contrast, using a lower number of acoustic transducers 1020 may decrease the computing power required by an associated controller 1050 to process the collected audio information. In addition, the position of each acoustic transducer 1020 of the microphone array may vary. For example, the position of an acoustic transducer 1020 may include a defined position on the user, a defined coordinate on frame 1010, an orientation associated with each acoustic transducer 1020, or some combination thereof.

Acoustic transducers 1020(A) and 1020(B) may be positioned on different parts of the user's ear, such as behind the pinna, behind the tragus, and/or within the auricle or fossa. Or, there may be additional acoustic transducers 1020 on or surrounding the ear in addition to acoustic transducers 1020 inside the ear canal. Having an acoustic transducer 1020 positioned next to an ear canal of a user may enable the microphone array to collect information on how sounds arrive at the ear canal. By positioning at least two of acoustic transducers 1020 on either side of a user's head (e.g., as binaural microphones), augmented-reality system 1000 may simulate binaural hearing and capture a 3D stereo sound field around about a user's head. In some embodiments, acoustic transducers 1020(A) and 1020(B) may be connected to augmented-reality system 1000 via a wired connection 1030, and in other embodiments acoustic transducers 1020(A) and 1020(B) may be connected to augmented-reality system 1000 via a wireless connection (e.g., a BLUETOOTH connection). In still other embodiments, acoustic transducers 1020(A) and 1020(B) may not be used at all in conjunction with augmented-reality system 1000.

Acoustic transducers 1020 on frame 1010 may be positioned in a variety of different ways, including along the length of the temples, across the bridge, above or below display devices 1015(A) and 1015(B), or some combination thereof. Acoustic transducers 1020 may also be oriented such that the microphone array is able to detect sounds in a wide range of directions surrounding the user wearing the augmented-reality system 1000. In some embodiments, an optimization process may be performed during manufacturing of augmented-reality system 1000 to determine relative positioning of each acoustic transducer 1020 in the microphone array.

In some examples, augmented-reality system 1000 may include or be connected to an external device (e.g., a paired device), such as neckband 1005. Neckband 1005 generally represents any type or form of paired device. Thus, the following discussion of neckband 1005 may also apply to various other paired devices, such as charging cases, smart watches, smart phones, wrist bands, other wearable devices, hand-held controllers, tablet computers, laptop computers, other external compute devices, etc.

As shown, neckband 1005 may be coupled to eyewear device 1002 via one or more connectors. The connectors may be wired or wireless and may include electrical and/or non-electrical (e.g., structural) components. In some cases, eyewear device 1002 and neckband 1005 may operate independently without any wired or wireless connection between them. While FIG. 10 illustrates the components of eyewear device 1002 and neckband 1005 in example locations on eyewear device 1002 and neckband 1005, the components may be located elsewhere and/or distributed differently on eyewear device 1002 and/or neckband 1005. In some embodiments, the components of eyewear device 1002 and neckband 1005 may be located on one or more additional peripheral devices paired with eyewear device 1002, neckband 1005, or some combination thereof.

Pairing external devices, such as neckband 1005, with augmented-reality eyewear devices may enable the eyewear devices to achieve the form factor of a pair of glasses while still providing sufficient battery and computation power for expanded capabilities. Some or all of the battery power, computational resources, and/or additional features of augmented-reality system 1000 may be provided by a paired device or shared between a paired device and an eyewear device, thus reducing the weight, heat profile, and form factor of the eyewear device overall while still retaining desired functionality. For example, neckband 1005 may allow components that would otherwise be included on an eyewear device to be included in neckband 1005 since users may tolerate a heavier weight load on their shoulders than they would tolerate on their heads. Neckband 1005 may also have a larger surface area over which to diffuse and disperse heat to the ambient environment. Thus, neckband 1005 may allow for greater battery and computation capacity than might otherwise have been possible on a stand-alone eyewear device. Since weight carried in neckband 1005 may be less invasive to a user than weight carried in eyewear device 1002, a user may tolerate wearing a lighter eyewear device and carrying or wearing the paired device for greater lengths of time than a user would tolerate wearing a heavy standalone eyewear device, thereby enabling users to more fully incorporate artificial-reality environments into their day-to-day activities.

Neckband 1005 may be communicatively coupled with eyewear device 1002 and/or to other devices. These other devices may provide certain functions (e.g., tracking, localizing, depth mapping, processing, storage, etc.) to augmented-reality system 1000. In the embodiment of FIG. 10, neckband 1005 may include two acoustic transducers (e.g., 1020(I) and 1020(J)) that are part of the microphone array (or potentially form their own microphone subarray). Neckband 1005 may also include a controller 1025 and a power source 1035.

Acoustic transducers 1020(I) and 1020(J) of neckband 1005 may be configured to detect sound and convert the detected sound into an electronic format (analog or digital). In the embodiment of FIG. 10, acoustic transducers 1020(I) and 1020(J) may be positioned on neckband 1005, thereby increasing the distance between the neckband acoustic transducers 1020(I) and 1020(J) and other acoustic transducers 1020 positioned on eyewear device 1002. In some cases, increasing the distance between acoustic transducers 1020 of the microphone array may improve the accuracy of beamforming performed via the microphone array. For example, if a sound is detected by acoustic transducers 1020(C) and 1020(D) and the distance between acoustic transducers 1020(C) and 1020(D) is greater than, e.g., the distance between acoustic transducers 1020(D) and 1020(E), the determined source location of the detected sound may be more accurate than if the sound had been detected by acoustic transducers 1020(D) and 1020(E).

Controller 1025 of neckband 1005 may process information generated by the sensors on neckband 1005 and/or augmented-reality system 1000. For example, controller 1025 may process information from the microphone array that describes sounds detected by the microphone array. For each detected sound, controller 1025 may perform a direction-of-arrival (DOA) estimation to estimate a direction from which the detected sound arrived at the microphone array. As the microphone array detects sounds, controller 1025 may populate an audio data set with the information. In embodiments in which augmented-reality system 1000 includes an inertial measurement unit, controller 1025 may compute all inertial and spatial calculations from the IMU located on eyewear device 1002. A connector may convey information between augmented-reality system 1000 and neckband 1005 and between augmented-reality system 1000 and controller 1025. The information may be in the form of optical data, electrical data, wireless data, or any other transmittable data form. Moving the processing of information generated by augmented-reality system 1000 to neckband 1005 may reduce weight and heat in eyewear device 1002, making it more comfortable to the user.

Power source 1035 in neckband 1005 may provide power to eyewear device 1002 and/or to neckband 1005. Power source 1035 may include, without limitation, lithium-ion batteries, lithium-polymer batteries, primary lithium batteries, alkaline batteries, or any other form of power storage. In some cases, power source 1035 may be a wired power source. Including power source 1035 on neckband 1005 instead of on eyewear device 1002 may help better distribute the weight and heat generated by power source 1035.

As noted, some artificial-reality systems may, instead of blending an artificial reality with actual reality, substantially replace one or more of a user's sensory perceptions of the real world with a virtual experience. One example of this type of system is a head-worn display system, such as virtual-reality system 1100 in FIG. 11, that mostly or completely covers a user's field of view. Virtual-reality system 1100 may include a front rigid body 1102 and a band 1104 shaped to fit around a user's head. Virtual-reality system 1100 may also include output audio transducers 1106(A) and 1106(B). Furthermore, while not shown in FIG. 11, front rigid body 1102 may include one or more electronic elements, including one or more electronic displays, one or more inertial measurement units (IMUs), one or more tracking emitters or detectors, and/or any other suitable device or system for creating an artificial-reality experience.

Artificial-reality systems may include a variety of types of visual feedback mechanisms. For example, display devices in augmented-reality system 1000 and/or virtual-reality system 1100 may include one or more liquid crystal displays (LCDs), light emitting diode (LED) displays, microLED displays, organic LED (OLED) displays, digital light project (DLP) micro-displays, liquid crystal on silicon (LCoS) micro-displays, and/or any other suitable type of display screen. These artificial-reality systems may include a single display screen for both eyes or may provide a display screen for each eye, which may allow for additional flexibility for varifocal adjustments or for correcting a user's refractive error. Some of these artificial-reality systems may also include optical subsystems having one or more lenses (e.g., concave or convex lenses, Fresnel lenses, adjustable liquid lenses, etc.) through which a user may view a display screen. These optical subsystems may serve a variety of purposes, including to collimate (e.g., make an object appear at a greater distance than its physical distance), to magnify (e.g., make an object appear larger than its actual size), and/or to relay (to, e.g., the viewer's eyes) light. These optical subsystems may be used in a non-pupil-forming architecture (such as a single lens configuration that directly collimates light but results in so-called pincushion distortion) and/or a pupil-forming architecture (such as a multi-lens configuration that produces so-called barrel distortion to nullify pincushion distortion).

In addition to or instead of using display screens, some of the artificial-reality systems described herein may include one or more projection systems. For example, display devices in augmented-reality system 1000 and/or virtual-reality system 1100 may include microLED projectors that project light (using, e.g., a waveguide) into display devices, such as clear combiner lenses that allow ambient light to pass through. The display devices may refract the projected light toward a user's pupil and may enable a user to simultaneously view both artificial-reality content and the real world. The display devices may accomplish this using any of a variety of different optical components, including waveguide components (e.g., holographic, planar, diffractive, polarized, and/or reflective waveguide elements), light-manipulation surfaces and elements (such as diffractive, reflective, and refractive elements and gratings), coupling elements, etc. Artificial-reality systems may also be configured with any other suitable type or form of image projection system, such as retinal projectors used in virtual retina displays.

The artificial-reality systems described herein may also include various types of computer vision components and subsystems. For example, augmented-reality system 1000 and/or virtual-reality system 1100 may include one or more optical sensors, such as two-dimensional (2D) or 3D cameras, structured light transmitters and detectors, time-of-flight depth sensors, single-beam or sweeping laser rangefinders, 3D LiDAR sensors, and/or any other suitable type or form of optical sensor. An artificial-reality system may process data from one or more of these sensors to identify a location of a user, to map the real world, to provide a user with context about real-world surroundings, and/or to perform a variety of other functions.

The artificial-reality systems described herein may also include one or more input and/or output audio transducers. Output audio transducers may include voice coil speakers, ribbon speakers, electrostatic speakers, piezoelectric speakers, bone conduction transducers, cartilage conduction transducers, tragus-vibration transducers, and/or any other suitable type or form of audio transducer. Similarly, input audio transducers may include condenser microphones, dynamic microphones, ribbon microphones, and/or any other type or form of input transducer. In some embodiments, a single transducer may be used for both audio input and audio output.

In some embodiments, the artificial-reality systems described herein may also include tactile (i.e., haptic) feedback systems, which may be incorporated into headwear, gloves, body suits, handheld controllers, environmental devices (e.g., chairs, floormats, etc.), and/or any other type of device or system. Haptic feedback systems may provide various types of cutaneous feedback, including vibration, force, traction, texture, and/or temperature. Haptic feedback systems may also provide various types of kinesthetic feedback, such as motion and compliance. Haptic feedback may be implemented using motors, piezoelectric actuators, fluidic systems, and/or a variety of other types of feedback mechanisms. Haptic feedback systems may be implemented independent of other artificial-reality devices, within other artificial-reality devices, and/or in conjunction with other artificial-reality devices.

By providing haptic sensations, audible content, and/or visual content, artificial-reality systems may create an entire virtual experience or enhance a user's real-world experience in a variety of contexts and environments. For instance, artificial-reality systems may assist or extend a user's perception, memory, or cognition within a particular environment. Some systems may enhance a user's interactions with other people in the real world or may enable more immersive interactions with other people in a virtual world. Artificial-reality systems may also be used for educational purposes (e.g., for teaching or training in schools, hospitals, government organizations, military organizations, business enterprises, etc.), entertainment purposes (e.g., for playing video games, listening to music, watching video content, etc.), and/or for accessibility purposes (e.g., as hearing aids, visual aids, etc.). The embodiments disclosed herein may enable or enhance a user's artificial-reality experience in one or more of these contexts and environments and/or in other contexts and environments.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A system comprising:
a conductive enclosure;
a first printed circuit board (PCB) that includes a plurality of antenna feeds; and
a second PCB that includes a grounding layer and one or more sensors,
wherein a first antenna feed of the plurality of antenna feeds is electrically connected to the conductive enclosure; and
wherein a second antenna feed of the plurality of antenna feeds is electrically connected to the grounding layer of the second PCB, such that the grounding layer of the second PCB acts as a radiating element for a second antenna.

2. The system of claim 1, further comprising a display shield that includes conductive material configured to electrically shield a display from one or more internal electronic components mounted to the first PCB.

3. The system of claim 2, wherein a third antenna feed of the plurality of antenna feeds is electrically connected to the display shield, such that the display shield acts as a radiating element for a third antenna.

4. The system of claim 3, wherein the first, second, and third antenna feeds each operate within different frequency bands.

5. The system of claim 3, wherein the third antenna feed electrically connected to the display shield comprises an ultrahigh band antenna.

6. The system of claim 1, wherein the first antenna feed electrically connected to the conductive enclosure comprises a low band cellular antenna.

7. The system of claim 1, wherein the second antenna feed electrically connected to the grounding layer of the second PCB comprises a mid-high band cellular antenna.

8. The system of claim 1, wherein the second antenna feed is electrically connected to a conductive portion of a substrate that is electrically connected to the second PCB.

9. The system of claim 1, further comprising one or more grounding connections between the first PCB and the conductive enclosure.

10. The system of claim 1, further comprising one or more grounding connections between the first PCB and a display shield.

11. The system of claim 1, further comprising a nonconductive bottom cover attached to the conductive enclosure, wherein the second PCB is affixed to the nonconductive bottom cover.

12. A mobile electronic device comprising:
a conductive enclosure;
a first printed circuit board (PCB) that includes a plurality of antenna feeds; and
a second PCB that includes a grounding layer and one or more sensors,
wherein a first antenna feed of the plurality of antenna feeds is electrically connected to the conductive enclosure; and
wherein a second antenna feed of the plurality of antenna feeds is electrically connected to the grounding layer of the second PCB, such that the grounding layer of the second PCB acts as a radiating element for a second antenna.

13. The mobile electronic device of claim 12, further comprising a display shield that includes conductive material configured to electrically shield a display from one or more internal electronic components mounted to the first PCB.

14. The mobile electronic device of claim 13, wherein a third antenna feed of the plurality of antenna feeds is electrically connected to the display shield, such that the display shield acts as a radiating element for a third antenna.

15. The mobile electronic device of claim 14, wherein the first, second, and third antenna feeds each operate within different frequency bands.

16. The mobile electronic device of claim 12, wherein the second antenna feed is electrically connected to a conductive portion of a substrate that is electrically connected to the second PCB.

17. The mobile electronic device of claim 12, further comprising one or more grounding connections between the first PCB and the conductive enclosure.

18. The mobile electronic device of claim 12, further comprising a nonconductive bottom cover attached to the conductive enclosure, wherein the second PCB is affixed to the nonconductive bottom cover.

19. The mobile electronic device of claim 12, wherein the mobile electronic device comprises at least one of a smartwatch, a smartphone, an internet of things (IoT) device, a pair of augmented reality glasses, or a virtual reality headset.

20. A method of manufacturing comprising:
providing a conductive enclosure;
mounting, to the conductive enclosure, a first printed circuit board (PCB) that includes a plurality of antenna feeds; and
mounting, to the enclosure, a second PCB that includes a grounding layer and one or more sensors,
wherein a first antenna feed of the plurality of antenna feeds is electrically connected to the conductive enclosure; and
wherein a second antenna feed of the plurality of antenna feeds is electrically connected to the grounding layer of the second PCB, such that the grounding layer of the second PCB acts as a radiating element for a second antenna.
